(19) United States
(12) Patent Application Publication
(10) Pub. No.: US 2012/0314246 A1
(43) Pub. Date: Dec. 13, 2012

(54) Printing Command Center Graphical User Interface

(76) Inventors: Janeen Jahn, Lafayette, CO (US); Joseph Gaertner, Lafayette, CO (US); Linda Liebelt, Boulder, CO (US); Allida Shoning, Longmont, CO (US); Cristian Popescu, Timisoara (RO); Irina Igna, Timisoara (RO); Kumar Kadiyala, Boulder, CO (US); Ady Babolanu, Timisoara (RO); Kyle Manning, Kaysville, CO (US); Marquis Waller, Beverly, OH (US)

(21) Appl. No.: 13/154,608

(22) Filed: Jun. 7, 2011

(51) Int. Cl. G06F 15/00

(52) U.S. Cl. 358/1.15

(57) ABSTRACT

A method disclosed. The method includes receiving a request to access print job objects at a remote server database from a graphical user interface (GUI) operating on a local server and displaying the print job objects from the remote server database at the GUI.

### FIELD OF THE INVENTION

The invention relates to the field of computer systems, and in particular, to printing software products.

### BACKGROUND

Printers are common peripheral devices attached to computers. A printer allows a computer user to make a hard copy of documents that are created in a variety of applications and programs on a computer. To function properly, a channel of communication is established (e.g., via a network connection) between the printer and the computer to enable the printer to receive commands and information from the host computer. Once a connection is established between a workstation and the printer, printing software is implemented at a print server to manage a print job from order entry and management through the complete printing process. The printing software often includes a graphical user interface (GUI) that enables users to control the printing process.

Typically, secondary servers are implemented by the printing software to assist the primary print server to offload CPU intensive work in order to improve performance. However because the secondary server does not have its own database, the secondary server is required to query across a network to the primary server for database accesses. In some geographies the lack of network reliability causes printing operations controlled by the secondary server to come to a total stop whenever there is a network outage.

Accordingly, a mechanism to provide reliable printing operations at a remote server is desired.

### SUMMARY

In one embodiment, a method includes receiving a request to access print job objects at a remote server database from a GUI operating on a local server and displaying the print job objects from the remote server database at the GUI.

Another embodiment discloses a print server including a processor, a database and a printing software product executed by the processor. The printing software product includes a GUI to receive a request to access print job objects from a remote server database to display the print job objects from the remote server database with print job objects from the local database.

In yet a further embodiment a computer system includes a processor and a GUI executed on the processor to display a command center window including two or more print server databases available for access.

### BRIEF DESCRIPTION OF THE DRAWINGS

A better understanding of the present invention can be obtained from the following detailed description in conjunction with the following drawings, in which:

FIG. 1 illustrates one embodiment of a data processing system network;

FIG. 2 is a flow diagram illustrating one embodiment for accessing a remote print server;

FIG. 3 illustrate screen shots of one embodiment of a printing software product;

FIG. 4 illustrate screen shots of another embodiment of a printing software product; and

FIG. 5 illustrates one embodiment of a computer system.

### DETAILED DESCRIPTION

A mechanism to simultaneously access multiple print servers is described. In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

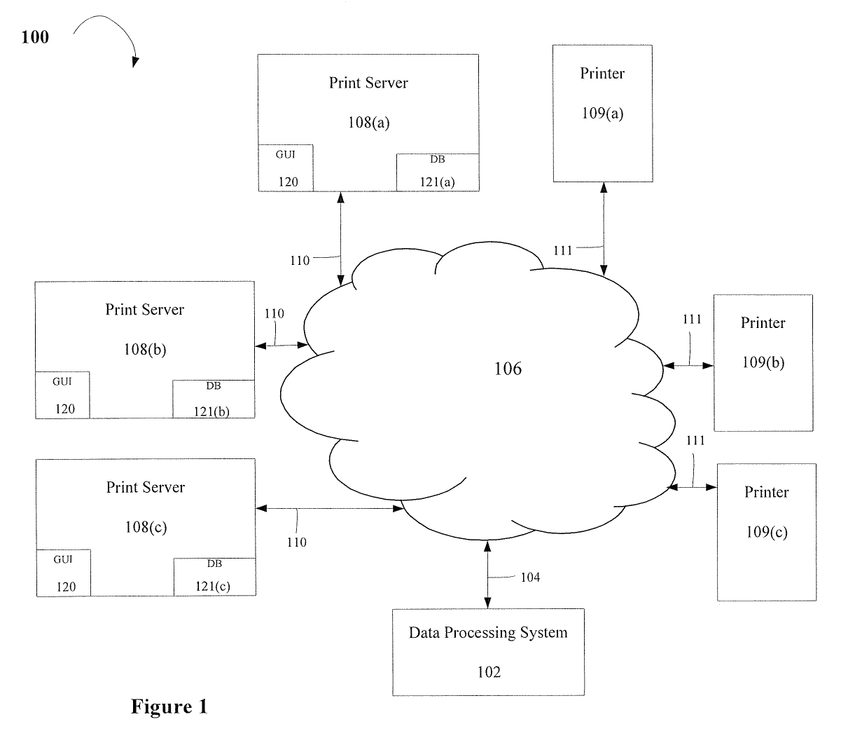

FIG. 1 illustrates one embodiment of a data processing system network 100. Network 100 includes a data processing system 102, which may be either a desktop or a mobile data processing system, coupled via communications link 104 to network 106. In one embodiment, data processing system 102 is a conventional data processing system including a processor, local memory, nonvolatile storage, and input/output devices such as a keyboard, mouse, trackball, and the like, all in accordance with the known art. In one embodiment, data processing system 102 includes and employs the Windows operating system or a similar operating system and/or network drivers permitting data processing system 102 to communicate with network 106 for the purposes of employing resources within network 106.

Network 106 may be a local area network (LAN) or any other network over which print requests may be submitted to a remote printer or print server. Communications link 104 may be in the form of a network adapter, docking station, or the like, and supports communications between data processing system 102 and network 106 employing a network communications protocol such as Ethernet, the AS/400 Network, or the like.

According to one embodiment, network 106 includes print servers 108 that serve print requests over network 106 received via communications link 110. Print servers 108 subsequently transmit the print requests via communications link 110 to one of printers 109 for printing, which are coupled to network 106 via communications links 111. In one embodiment, an operator at data processing system 102 may interact with print servers 108 using a GUI 120 to submit requests for service to one or more of printers 109 over network 106.

According to one embodiment, each print server 108 may be configured to control a single printer (e.g., print server 108(a) controls printer 109(a), print server 108(b) controls printer 109(b), etc.). Alternatively, each print server 108 may control all printers 109, or some combination thereof. In a further embodiment, each print server 108 includes a database implemented to process print jobs requested by remote data processing systems. Since each site has its own database, if the communication between two sites is down, each site is still capable of receiving and processing printing jobs.

Although described as separate entities, other embodiments may include a print server 108 being incorporated in one or more of the printers 109. Therefore, the data processing system network depicted in FIG. 1 is selected for the purposes of explaining and illustrating the present invention and is not intended to imply architectural limitations. Those skilled in the art will recognize that various additional components may be utilized in conjunction with the present invention.

According to one embodiment, print servers 108 implement a printing software product that manages the printing of documents from data processing system 102 to one or more of printers 109. In other embodiments, the printing software manages printing of documents from multiple data processing systems 102 to printers 109.

According to one embodiment, the printing software product may be implemented using either InfoPrint Manager (IPM) or InfoPrint ProcessDirector (IPPD), although other types of printing software may be used instead. In a further embodiment, the print printing software product includes GUI 120 that enables a system administrator (or operator) to interact with the print printing software product at printer servers 108.

In one embodiment, GUI 120 enables an operator to log in and log out of each server 108. Once logged in, the operator may access a server 108 database in order to view and/or edit print job operations. Thus, GUI 120 includes a command center window that enables the operator to view objects from all servers 108 for which the operator is logged in.

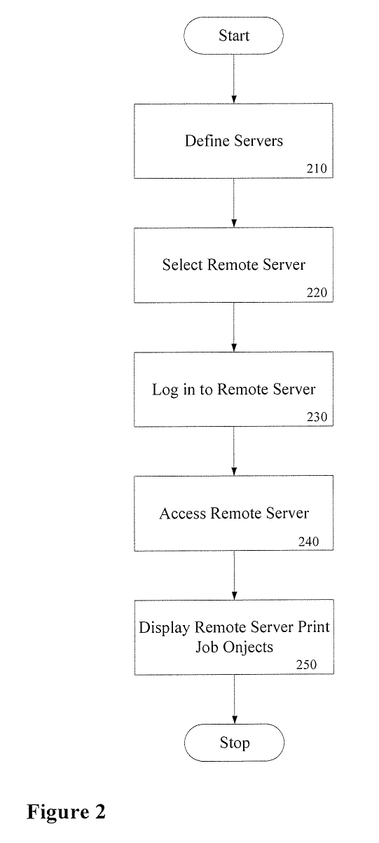

FIG. 2 is a flow diagram illustrating one embodiment for GUI accessing a remote print server from a local print server. At processing block 210, both the local server and remote server are defined at GUI 120. For example, an operator at GUI 120 defines the properties for the remote server with the local server and subsequently defines the properties for the local server with the remote server.

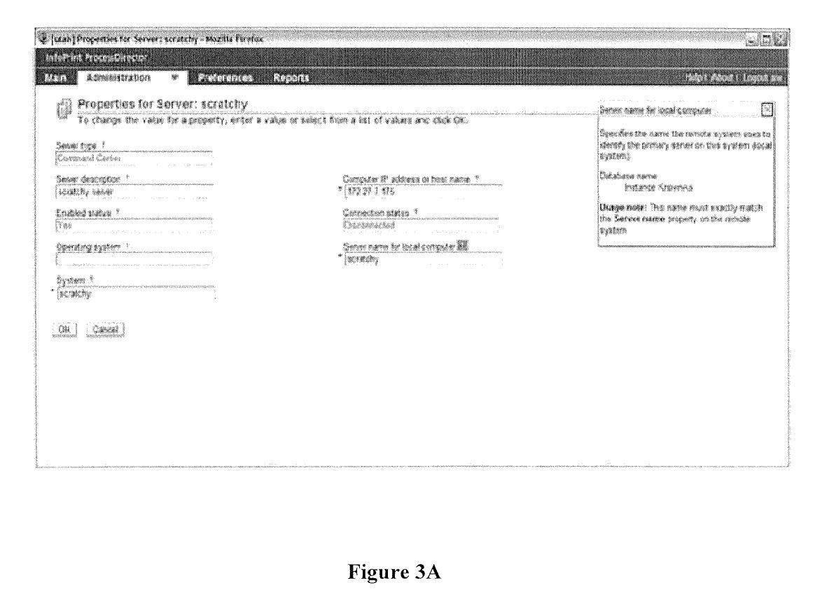

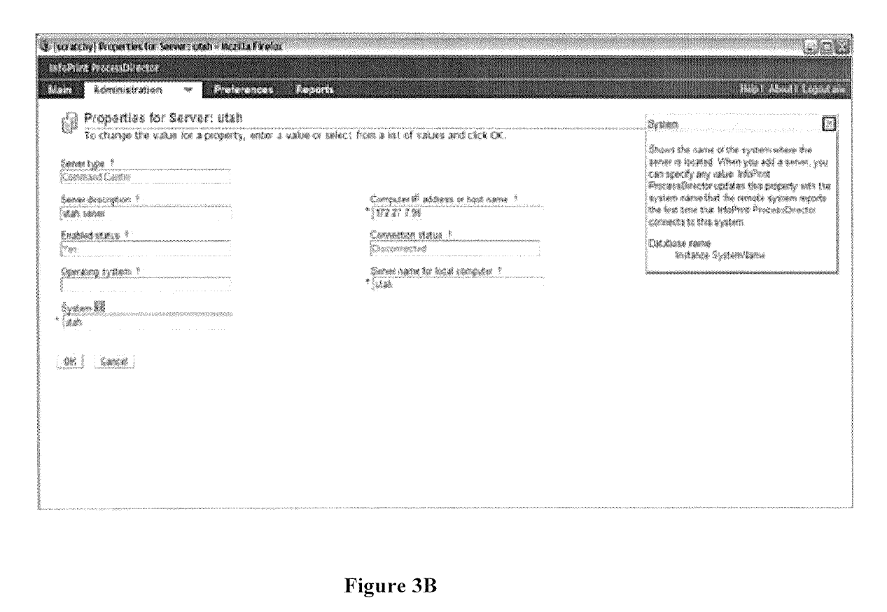

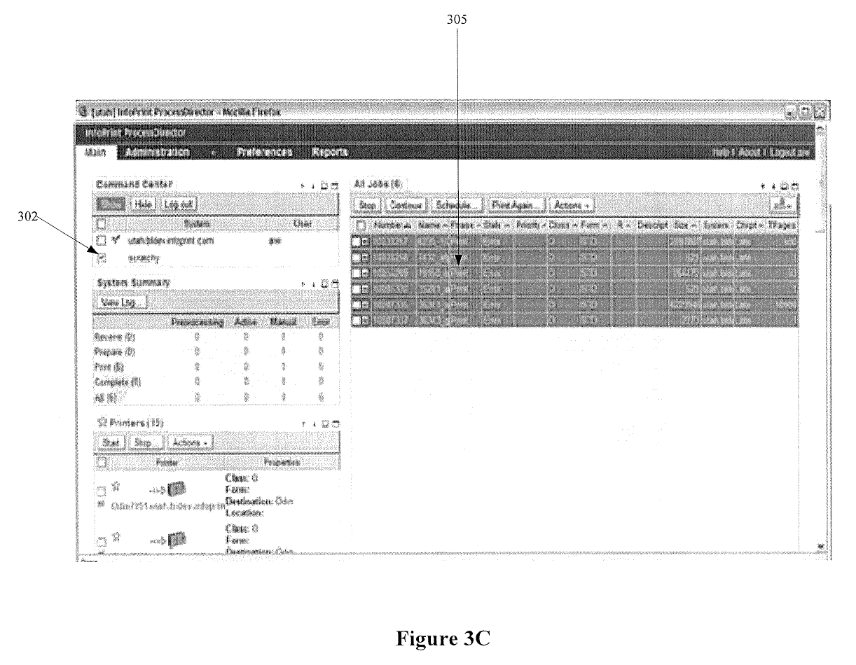

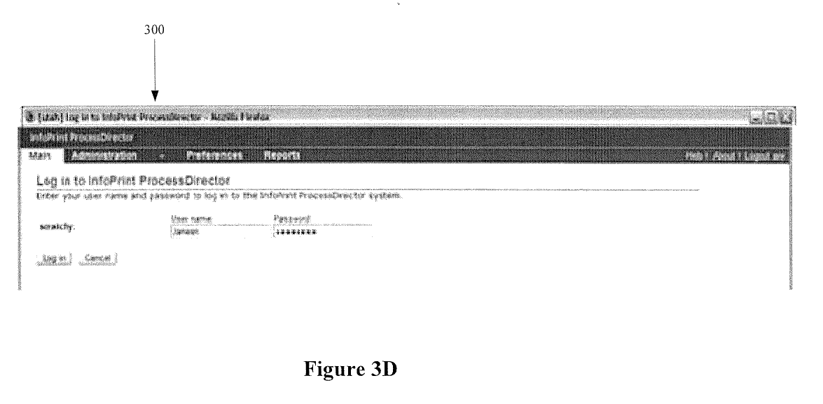

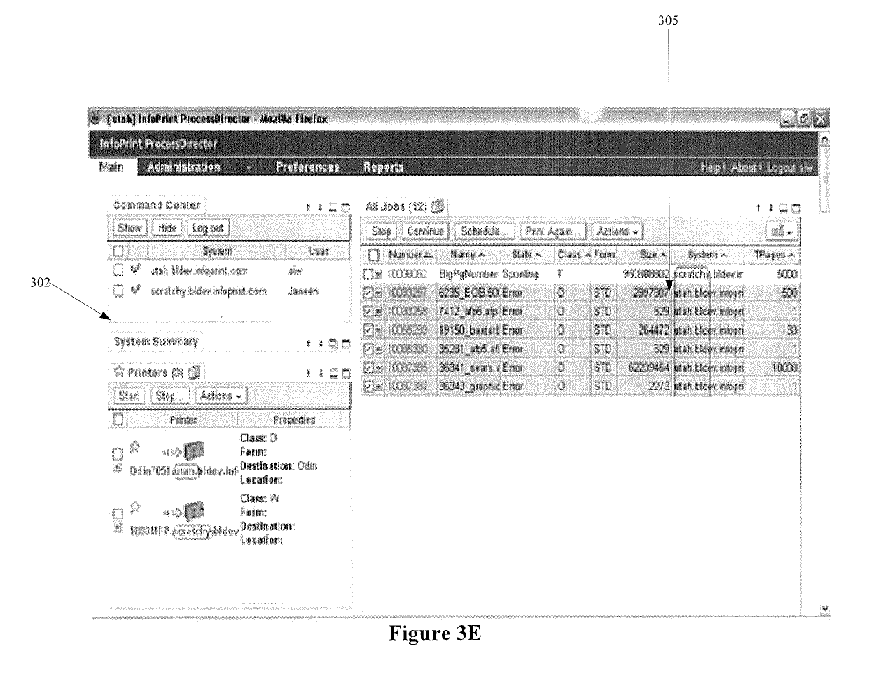

FIG. 3A illustrates a screen shot of one embodiment of the GUI 120 while defining properties for the remote server with the local server. As shown in FIG. 3A, the remote server is referred to as “scratchy” while the local server is referred to as “utah”. The properties defined for “scratchy” at “utah” include server name, type, IP address, etc. Similarly, FIG. 3B illustrates a screen shot for one embodiment of the GUI 120 while defining properties for the local server “utah” with the remote server “scratchy”.

Referring back to FIG. 2, the remote server is subsequently selected while logged into the local server, processing block 220. FIG. 3C illustrates a screen shot of one embodiment of GUI 120 while selecting the remote server “scratchy” in a command center window 302 while on the local server “utah”. As shown in FIG. 3C, “scratchy” is selected in command center 302, while “utah” print jobs are shown in a jobs 305 window.

Referring back to FIG. 2, the operator is prompted to log into the remote server, processing block 230. FIG. 3D illustrates a screen shot of one embodiment of a login screen at GUI 120 for the remote server “scratchy”. At processing block 240, the operator is granted access to both the local server and the remote server via the GUI 120 command center. At processing block 250, print job objects from both the local server and the remote server are displayed within GUI 120. In other embodiments print system objects (e.g., documents within a print job) may also be displayed.

FIG. 3E illustrates a screen shot of one embodiment of GUI 120 after access has been granted to both the local server “utah” and the remote server “scratchy”, as shown in command center 302. Further shown in FIG. 3E is that both servers are active in the command center, while print jobs for both are shown in the jobs 305 window.

According to one embodiment, GUI 120 may be used to move print jobs between servers 108 during various points in their processing. For instance, a job can be moved from the beginning, which would take the original files as received on the source system. Jobs may also also be moved “from current”, which would take the current files from a job's directory. The “current” files may have already been converted or otherwise processed on the source server and would not need processing on the destination server.

In one embodiment, the GUI 120 command center enables an operator at the local server to hide a logged in remote server in order to prevent remote server print jobs from showing. In such an embodiment, the hidden remote server objects can again be shown from the hidden logged server by using the command center. In a further embodiment, GUI 120 will call a method requesting a file stream whenever a view action is made for a print job that resides on a remote server.

In such an embodiment, the file is sent using the SSL sockets in order to maintain security. In a further embodiment, GUI 120 generates a temporary file that is saved to a previously determined location that will be used to view the job. When viewing of the specified file has been completed the file is removed from the system where the command center is installed.

According to one embodiment, GUI 120 verifies a user's authority to perform actions on a remote server. In such an embodiment, every GUI action uses the facade to verify if an action can be performed when a displayed action menu item is selected (or clicked). For example, GUI 120 can make a call to a remote server to verify that a user is authorized to perform a requested action at the remote server prior to issuing a call for the remote server to perform the action. In another embodiment, the user's authority to perform action may be verified at the local server, rather than making the call to the remote server.

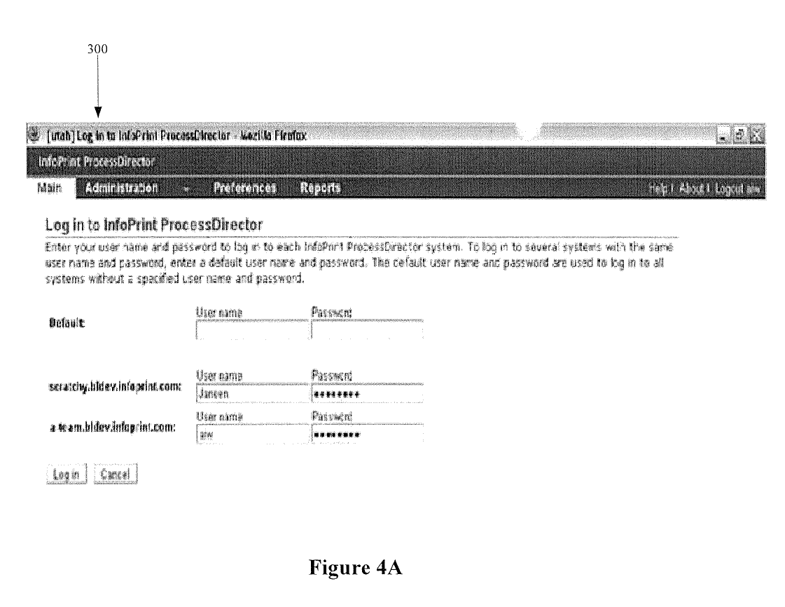

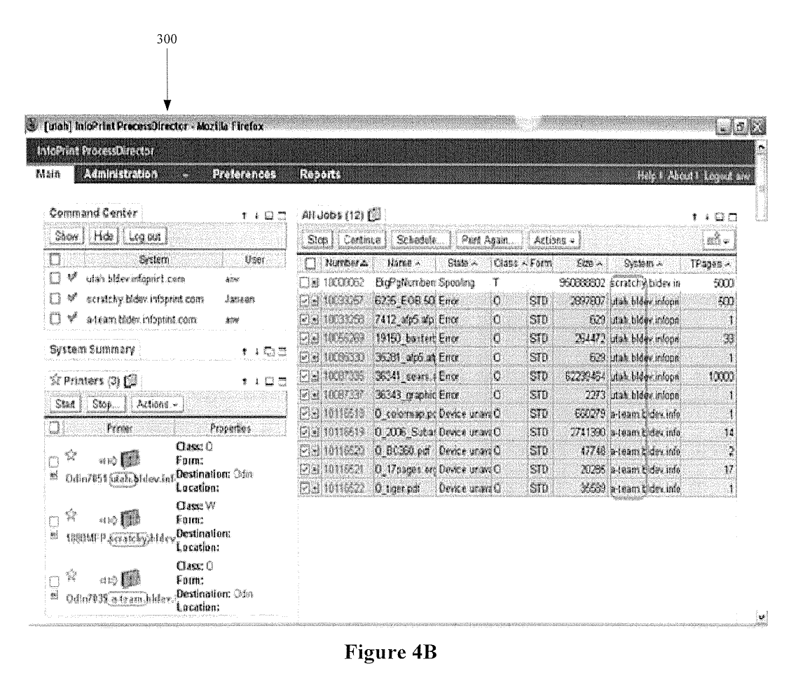

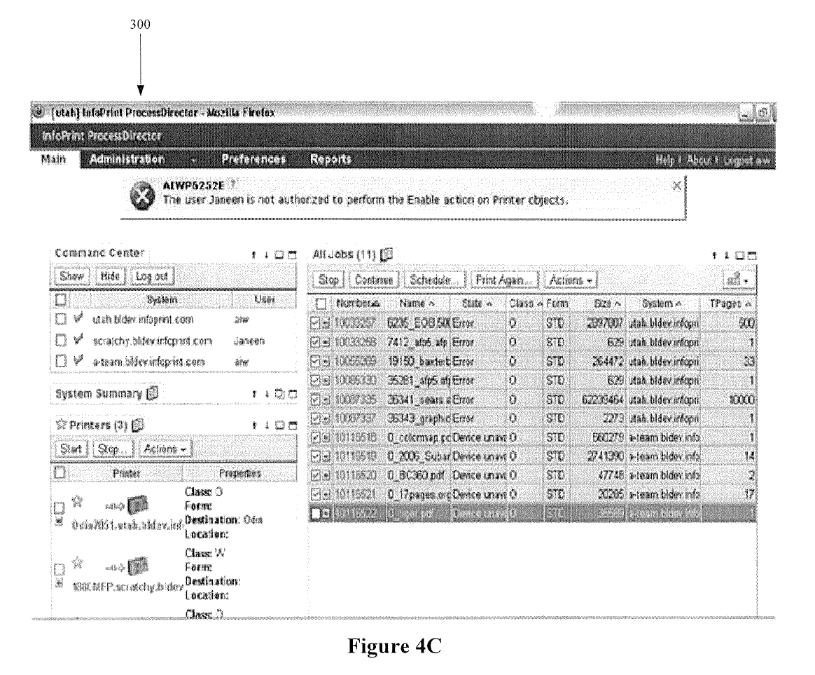

FIG. 4A illustrates a screen shot of another embodiment of a login screen at GUI 120 for remote servers “scratchy” and “a-team”. In this embodiment, an operator may sign into multiple servers using different passwords for each server. However in other embodiments, the same password may be used. Further, the operator may have different access levels for each server. For instance, the operator may be authorized to perform actions at remote server “scratchy”, while having only authorization to view print job objects at remote server “a-team”.

After successful login, objects from all servers are shown on the main window of GUI 120. FIG. 4B illustrates a screen shot of one embodiment of GUI 120 after access has been granted to local server “utah” and remote servers “scratchy” and “a-team”, as shown in command center 302. Further shown in FIG. 4B is that all servers are active in the command center, while print jobs for the servers are shown in the jobs 305 window. However, the user does not have privileges to work with printer objects on remote server “scratchy”. Thus, even though the user would see an action (e.g., Enable) available from GUI 120 when selecting a job an remote server “scratchy”, the user will receive an error message on GUI 120 upon attempting to perform the action on the job, as shown in FIG. 4C. FIG. 4C illustrates a screen shot of one embodiment of GUI 120 displaying an error message after a user has attempted to enable the 1880MFP printer on remote server “scratchy”.

The above-described GUI command center enables an operator to view operations, printers and jobs at all servers in a printing network. Additionally, the operator may move print jobs from one server to another server.

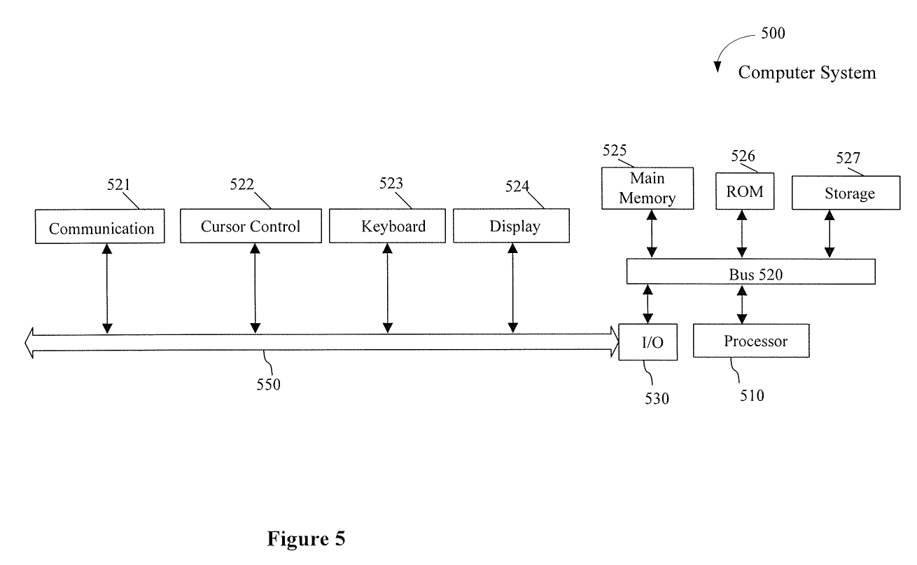

FIG. 5 illustrates a computer system 500 on which data processing system 102 and/or servers 108 may be implemented. Computer system 500 includes a system bus 520 for communicating information, and a processor 510 coupled to bus 520 for processing information.

Computer system 500 further comprises a random access memory (RAM) or other dynamic storage device 525 (referred to herein as main memory), coupled to bus 520 for storing information and instructions to be executed by processor 510. Main memory 525 also may be used for storing temporary variables or other intermediate information during execution of instructions by processor 510. Computer system 500 also may include a read only memory (ROM) and or other static storage device 526 coupled to bus 520 for storing static information and instructions used by processor 510.

A data storage device 525 such as a magnetic disk or optical disc and its corresponding drive may also be coupled to computer system 500 for storing information and instructions. Computer system 500 can also be coupled to a second I/O bus 550 via an I/O interface 530. A plurality of I/O devices may be coupled to I/O bus 550, including a display device 524, an input device (e.g., an alphanumeric input device 523 and or a cursor control device 522). The communication device 521 is for accessing other computers (servers or clients). The communication device 521 may comprise a modem, a network interface card, or other well-known interface device, such as those used for coupling to Ethernet, token ring, or other types of networks.

Embodiments of the invention may include various steps as set forth above. The steps may be embodied in machine-executable instructions. The instructions can be used to cause a general-purpose or special-purpose processor to perform certain steps. Alternatively, these steps may be performed by specific hardware components that contain hardwired logic for performing the steps, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as essential to the invention.

What is claimed is:

1. A computer generated method comprising:
receiving a request to access print job objects at a remote server database from a graphical user interface (GUI) operating on a local server; and
displaying the print job objects from the remote server database at the GUI.

2. The method of claim 1 wherein the print job objects from the remote server database are displayed in a GUI window with print job objects from a local server database.

3. The method of claim 1 further comprising:
displaying a login screen at the GUI to prompt an operator to login to the remote server after receiving the request to access print job objects a remote server database; and
granting access to the remote server database upon receiving authorized login data.

4. The method of claim 3 further comprising defining remote server properties at the local server and defining local server properties at the remote server.

5. The method of claim 1 further comprising:
receiving a request to perform an action on a print job object at the remote server database;
verifying an authorization to perform the requested action; and
performing the action if authorization is verified.

6. The method of claim 5 further comprising:
rejecting performing the action if authorization is not verified; and
displaying an error message at the GUI indicating no authorization to perform the action.

7. The method of claim 1 further comprising moving a print job from the remote server database to the local server database.

8. The method of claim 1 further comprising hiding print job objects from the remote server at the GUI.

9. A print server, comprising:
a processor;
a local database;
a printing software product including a graphical user interface (GUI) to be executed by the processor to receive a request to access print job objects from a remote server database and to display the print system objects from the remote server database with print job objects from the local database.

10. The print server of claim 9 wherein the printing software product receives a request to perform an action on a print system object at the remote server database, verifies an authorization to perform the requested action and performs the action if authorization is verified.

11. The print server of claim 10 wherein the printing software product rejects performing the action if authorization is not verified and displays an error message at the GUI indicating no authorization to perform the action.

12. The print server of claim 9 wherein the printing software product moves a print job from the remote server database to the local database upon receiving a request.

13. A computer system, comprising:
a processor;
a graphical user interface (GUI) executed on the processor, to display a command center window including two or more print server databases available for access.

14. The computer system of claim 13 wherein the GUI further displays a print job window listing print job objects from each of the two or more print server databases.

15. The computer system of claim 13 wherein the GUI further displays a login screen to prompt an operator to login to one or more remote servers.

16. An article of manufacture comprising a machine-readable medium including data that, when accessed by a machine, cause the machine to perform operations comprising:
receiving a request to access print job objects at a remote server database from a graphical user interface (GUI) operating on a local server; and
displaying the print job objects from the remote server database at the GUI.

17. The method of claim 2 wherein the print job objects from the remote server database are displayed in a GUI window with print job objects from a local server database.

18. The article of manufacture of claim 16 comprising a machine-readable medium including data that, when accessed by a machine, further cause the machine to perform operations comprising:
verifying an authorization to perform the requested action; and
performing the action if authorization is verified.

19. The article of manufacture of claim 18 comprising a machine-readable medium including data that, when accessed by a machine, further cause the machine to perform operations comprising:
rejecting performing the action if authorization is not verified; and
displaying an error message at the GUI indicating no authorization to perform the action

20. The article of manufacture of claim 16 comprising a machine-readable medium including data that, when accessed by a machine, further cause the machine to perform operations comprising moving a print job from the remote server database to the local server database.
